(19) United States
(12) Patent Application Publication
(10) Pub. No.: US 2020/0286396 A1
(43) Pub. Date: Sep. 10, 2020

(54) Following teaching system having voice evaluation function

(71) Applicant: Shenzhen Eaglesoul Audio Technologies CO.,Ltd., Shenzhen (CN)

(72) Inventors: Qiwei LU, Pu'ning (CN); Xiaojiao BIN, Zhaotong (CN)

(21) Appl. No.: 16/467,493

(22) PCT Filed: Dec. 4, 2017
(86) PCT No.: PCT/CN2017/114403

§ 371 Date: Jun. 6, 2019

(30) Foreign Application Priority Data
Nov. 17, 2017 (CN) 201711142046.7

(51) Int. Cl. G09B 5/06; G10L 15/26; G09B 5/12

(52) U.S. Cl. CPC G09B 5/065; G09B 5/12; G10L 15/265

(57) ABSTRACT

There is provided an Internet teaching platform-based following teaching system having a voice evaluation function. By using a recording and broadcasting system of an Internet teaching platform, recording class teaching of a standard teacher and then performing standardization segmentation processing on data of the recorded class teaching, a standard teaching recorded and broadcast course is formed, and after learning the standard teaching recorded and broadcast course, a following teacher can imitate the standard teacher to perform local class teaching, which is also recorded by the recording and broadcasting system. By using the system to perform processing of relationship construction, statistics, analysis and comparison on a variety of collected data, the recording and guiding before, during and after a teaching process of the following teacher can be realized, and a voice of the following teacher can be evaluated to facilitate the following teacher in effectively completing the local class teaching.

### CROSS-REFERENCE TO RELATED APPLICATIONS

This application is a national stage application of PCT Application No. PCT/CN2017/114403. This Application claims priority from PCT Application No. PCT/CN2017/114403, filed Dec. 4, 2017, and CN Application No. 201711142046.7, filed Nov. 17, 2017, the content of which is incorporated herein in the entirety by reference.

Some references, which may include patents, patent applications, and various publications, are cited and discussed in the description of the present disclosure. The citation and/or discussion of such references is provided merely to clarify the description of the present disclosure and is not an admission that any such reference is “prior art” to the present disclosure described herein. All references cited and discussed in this specification are incorporated herein by reference in their entireties and to the same extent as if each reference was individually incorporated by reference.

### TECHNICAL FIELD

The present invention relates to the technical field of Internet teaching, and in particular to an Internet teaching platform-based following teaching system having a voice evaluation function.

### BACKGROUND ART

In recent years, with the flourishing of Internet teaching technology, a large number of various Internet teaching platforms have emerged. These Internet teaching platforms make the sharing of teaching resources more convenient by means of Internet technology, and they mainly make audio and video contents on site, such as class teaching, lectures, and conferences, and even the contents for integrated presentation into multimedia files, and store same on a teaching server connected to the Internet, such that by means of the on demand and live broadcasting technologies, a user can watch online or review these teaching contents over the Internet anytime and anywhere. With the increasing popularity of the Internet, particularly the mobile Internet, Internet users can conveniently conduct online teaching, remote teaching, class live broadcasting, etc. However, these Internet teaching platforms mainly focus on the recording of the teaching process and the interaction between teachers and students, for example, such teaching recording and broadcasting systems or teaching platforms in the prior art:

CN101833882A (Date of Publication: Sep. 15, 2010) discloses a course recording system for teaching, comprising a multimedia classroom module (such as a dais, a central control, a stand, a notebook and a projector), a classroom scene camera collection module, an automatic tracking and detection module, a recording and broadcasting workstation, a B/S architecture on-demand module, an edit workstation, a recording and broadcasting system resource management module, external conditions, etc.

CN106355350A (Date of Publication: Jan. 25, 2017) discloses a smart campus system, comprising a campus management subsystem 1 and a campus teaching subsystem 2, wherein a smart reading assessment subsystem can analyze, calculate and rank the received data, such as the frequency and time at which students enter and leave a reading room, and the titles and number of the books that they read, and then present a ranking list on a cloud interactive electronic blackboard 108 so as to stimulate the students' enthusiasm for learning.

CN105306861A (Date of Publication: Feb. 3, 2016) discloses a reliable teaching recording and broadcasting method for a system, the method comprising: separately storing the recording and classification of classified data, generating a unified time stamp for marking, performing simple segmentation on data that needs to be encrypted to establish a correlation table, and separately acquiring recorded data according to demands, so as to realize smooth transfer of data. In addition, these pieces of data are organically combined by using a client on a local terminal, and even only part of data is acquired for broadcasting according to the demands of the client, such that the problem of teaching recording and broadcasting is systematically solved.

CN103295171A (Date of Publication: Sep. 11, 2013) discloses an intelligent recording and broadcasting system-based automatic S-T teaching analysis method, the system comprising an audio and video on-site collection and recording and broadcasting system, a network transmission system and a remote broadcasting system, and the method comprising the following steps: I. acquiring a switching mode for a signal source in the process of recording performed by the audio and video on-site collection and recording and broadcasting system; II. performing conversion processing on the switching mode and generating an xml file; III. defining parameters in a video source file of the xml file as teacher and student behaviors; IV. calculating the percentage of the teacher behavior, the percentage of the student behavior, and a conversion rate; and V. presenting a graph of S-T behaviors by using a web interface. By means of the present invention, a teacher can record and broadcast a course, while a recording and broadcasting host converts intelligent switching information about a video source position into a teacher behavior information sequence table and a student behavior information sequence table, and after the recording of a video is completed and is subjected to automatic encoding, an intuitive S-T histogram can be directly generated so as to calculate the conversion rate of this lesson example and determine the type of teaching according to a norm.

CN106485964 A (Date of Publication: Mar. 8, 2017) discloses a system for the recording and on-demand of class teaching, comprising: during course recording, according to main points for explanation in class and by means of generating a specific identifier of a time stamp, marking and segmenting recorded class teaching data, and constructing an association relational database for the correspondences between the main points for explanation in class and the segmented teaching data. The class teaching data may be combined data composed of an action stream, an audio stream, and an image stream. Particularly preferably, the “marking and segmentation” of the recorded class teaching data of the present invention does not substantially cut or segment the recorded class teaching data, but identifying same in segments by means of an identifier of time tamp, and such marking and segmentation may be of multiple levels, not one segment only corresponding to one point for explanation. The use of time stamp identifiers facilitates the establishment of correlations for different levels of “segmented and identified data” according to needs. The method comprises: a course recording step, which is used for recording class teaching data, segmenting and identifying the recorded class teaching data in a time order of main points for explanation in class so as to form segmented and marked class data corresponding to the main points for explanation in class, and establishing an association database for the correspondences between the main points for explanation in class and the segmented and marked class data. The main points for explanation in class comprise multiple different levels of main points having a high-low affiliation relationship. According to different levels of main points involved in the recorded class teaching data, the segmented and marked class data can correspond to the corresponding specific main points of a lower level and main points of a high level thereof, and a correlation list is established in the corresponding database for associations according to a time relationship. A collection device respectively collects an image data stream + a time stamp, an audio data stream + a time stamp and an action data stream + a time stamp during the lecturing by a teacher, and respectively distributes same in real time via a server, such that online live broadcasting of a class is realized, and a user terminal of a student acquires the three types of distributed data streams in real time and locally recombined same according to time stamps so as to realize online learning. The time stamps are uniformly generated by a teaching server. The image data stream + a time stamp, an audio data stream + a time stamp and an action data stream + a time stamp obtained by the collection device are processed and then stored in a storage device, wherein the storage device may be a local memory (a local disk array) or a network cloud memory and any combination thereof.

It can be seen that the technical problems to be solved by various teaching systems in the prior art mainly lie in the techniques in terms of the recording of a teaching process, online sharing, interactive learning, etc., aiming to collect class teaching data via a recording and broadcasting system and transmit the collected teaching data over the network, such that the class teaching can be reproduced on a user client of a student so as to achieve the purpose of network teaching.

The inventor of the present application have intensively implemented the technical project in the front-line teaching of primary and secondary schools, and especially in the investigation of remote mountain areas, it is difficult for the students in the areas to directly learn, due to the reasons in such aspects as teaching background and knowledge background, the network teaching courses provided in education developed areas, and the learning effect is relatively poor even if following learning is conducted, which needs a local teacher to firstly learn the network courses and then conduct actual teaching activities by means of a local class teaching mode with reference to the teaching mode for network teaching courses and also conjunction with actual situations. Objectively speaking, the teaching subject and core strength for education in primary and secondary schools are surely still primary and secondary school teachers for a relatively long period now and in the future, and it is foreseeable that various modern teaching means will be increasingly adopted in the future, but the main teaching activities will still be performed by means of class teaching. At present, for the education in primary and secondary schools, various network teaching systems mainly play the role of real-time assistance in class teaching, process extension, etc., and cannot completely replace the class teaching. Front-line teachers, especially those in underdeveloped areas who are eager to improve the teaching level, have such a demand: during the process of conducting the following teaching of the network teaching courses provided in education developed areas, that is, during the processing like imitative teaching, the teachers in underdeveloped areas (local teachers) hope to provide, with the help of technologies or software systems capable of analyzing and assisting the process of following teaching in real time, technical support for the process of following teaching of local teachers, so as to facilitate the improvement in the teaching level of the local teachers and in the teaching quality and teaching effect of local teaching, that is to say, it has not been proposed in the prior art to form a standard teaching recorded and broadcast course and a following teaching recorded and broadcast course for comparing same in segments, and synchronously playing back and displaying same to a follow teacher, so as to analyze and guide the following class teaching. What is more special about the present invention is that in today's increasing attention to standardization and Mandarin, for following teachers, especially those in remote mountain areas, it is also very necessary to conduct appropriate evaluation on voice pronunciation thereof during a following teaching process.

By means of retrieval and analysis of the prior art, the inventor has not found that there is an Internet teaching platform-based following teaching scheme in the prior art. The present invention is directed to the problem, existing in the prior art, discovered by the inventor. Over the Internet teaching platform, a teaching recording and broadcasting system is used to collect, analyze and evaluate related data before, during and after the process of a following teacher conducting following class teaching, so as to provide real-time analysis, guidance and assistance, which not only can analyze and guide the whole following class teaching, but also can evaluate the pronunciation of the following teacher, thereby facilitating improving the efficiency and teaching effect of following teaching.

### SUMMARY OF THE INVENTION

In order to solve the above-mentioned technical problems, the present invention provides an Internet teaching platform-based following teaching system, wherein the following teaching system is based on an Internet teaching platform, the Internet teaching platform has a class teaching recording function, and the teaching recording is implemented by using a teaching recording and broadcasting system. The following teaching system comprises the following units:

a standard course forming unit for collecting standard class teaching data of a standard teacher by using a standard teaching recording and broadcasting system of the Internet teaching platform, and processing the standard class teaching data in segments, for example, in a pre-class test stage, a class lecturing stage and an in-class practice stage, wherein each of the stages is identified and distinguished by using information about a time identifier, and the information about a time identifier is saved together with the class teaching data so as to constitute standard teaching recorded and broadcast data, thereby forming a standard teaching recorded and broadcast course;

a following teaching recording unit for collecting following class teaching data of a following teacher by using a following teaching recording and broadcasting system of the Internet teaching platform, analyzing pre-class test result data of the following class teaching data in real time, comparing the results analyzed in real time with corresponding data of the standard teaching recorded and broadcast data, setting a suggested lecturing time for a class lecturing stage of the following teacher according to a comparison result, and recording the suggested lecturing time and an actual lecturing time, wherein the suggested lecturing time and the actual lecturing time are saved together with the class teaching data so as to constitute following teaching recorded and broadcast data, thereby forming a following teaching recorded and broadcast course, and the following teaching recorded and broadcast data comprises the voice data of the following teacher;

a following teaching analysis unit for analyzing the following teaching recorded and broadcast data ex post facto, comparing same with the standard teaching recorded and broadcast data in segments, including the comparison between the suggested lecturing time and the actual lecturing time in each of the stages, and the comparison of information about voice text in each of the stages, and synchronously playing back the following teaching recorded and broadcast course and the standard teaching recorded and broadcast course and displaying same to the following teacher; and

a following voice evaluation unit for comparing a teaching voice of the following teacher with a standard teaching voice and marking a comparison result on voice text of the following teacher.

The standard course forming unit specifically comprises:

a relational data construction unit for dividing knowledge points of a class syllabus of each course, generating keywords by using the knowledge points as data items and according to the knowledge points, establishing a correlation between the keywords and the knowledge points, and establishing, on the basis of the data items and according to the comparison of information about attributes between exercises in a pre-class test and exercises in in-class practice, an association relationship, which takes the knowledge points as associated points, among various types of data, thereby constructing a relational database;

a standard teaching recording unit for collecting the standard class teaching data by using a teaching recording device of the standard teaching recording and broadcasting system, wherein image data, audio data and motion data are collected respectively by using an image collection device, an audio collection device and/or a motion collection device, and the data can be respectively saved in the form of data streams and can be time stamped by a time stamp;

a pre-class test analysis unit for performing real-time analysis on test results of a basic knowledge test conducted by a student over a student terminal after the start of class teaching and before the class lecturing stage, so as to form pre-class test result analysis data;

an in-class practice analysis unit for performing real-time analysis on test results of an in-class practice test conducted by a student over a student terminal before the end of class teaching and after the class lecturing stage, so as to form in-class practice result analysis data; and

a voice recognition and conversion unit for converting audio data of the class teaching data into information about voice text by using a voice recognition technology, and counting word frequency numbers of keywords in information about standard voice text corresponding to each of the knowledge points.

The information about standard voice text comprises information about a time stamp of the audio data, such that a correlation between voice text and the audio data can be established based on the information about a time stamp, and thus the information about standard voice text can be displayed in the form of subtitles when the standard teaching recorded and broadcast course is played back on-demand.

The division of the knowledge points comprises three steps:

step I: dividing the class syllabus into basic knowledge and newly lectured knowledge to serve as a first-level data item;

step II: further dividing the basic knowledge into several basic knowledge points, and further dividing the newly lectured knowledge into several newly lectured knowledge points to serve as a second-level data item;

and step III: based on the association relationship between the basic knowledge points and the newly lectured knowledge points, further improving the data structure of the relational database.

The following teaching recording unit specifically comprises:

a relational data invoking unit for retrieving the relational database at the beginning of following class teaching, so as to provide data support for the following execution of unit functions;

a following teaching data collection unit for collecting the following class teaching data by using a teaching recording device of a following teaching recording and broadcasting system, wherein image data, audio data and motion data are collected respectively by using an image collection device, an audio collection device and/or a motion collection device, and the data can be respectively saved in the form of data streams and can be time stamped by a time stamp;

a pre-class test comparison unit for performing real-time analysis on test results of a basic knowledge test conducted by a student over a student terminal after the start of following class teaching and before a following class lecturing stage so as to form pre-class test result analysis data, comparing the pre-class test analysis result with a pre-class test analysis result of a standard course, providing, to the following teacher, the student's master of the basic knowledge points as well as the difference between the student and a student in a standard class, and giving a suggested lecturing time concerning the knowledge points according to the difference and information about an association of the knowledge points in the relational database in conjunction with a lecturing time for the knowledge points in standard class; and

an in-class practice analysis unit for performing real-time analysis on test results of an in-class practice test conducted by a student over a student terminal before the end of class teaching and after the class lecturing stage, so as to form in-class practice result analysis data.

The exercises in the pre-class test and the exercises in the in-class practice are consistent with the corresponding exercises in standard teaching.

After the giving of the suggested lecturing time, information about a time prompt is generated and presented on a teacher terminal, making it convenient for the following teacher to control the teaching progress in class lecturing.

The following teaching analysis unit specifically comprises:

a voice recognition and conversion unit for converting audio data of the following teaching recorded and broadcast data into information about voice text by using a voice recognition technology, and counting word frequency numbers of keywords in information about following voice text corresponding to each of the knowledge points, wherein the keywords are consistent with keywords in a standard course;

a text similarity analysis unit for performing comparative analysis on the word frequency numbers of the keywords corresponding to each of the knowledge points in the information about standard voice text and the word frequency numbers of the keywords corresponding to each of the knowledge points in the information about following voice text, so as to determine the similarity between the information about following voice text and the information about standard voice text; and

a split-screen comparison presentation unit for simultaneously presenting, to the following teacher, the recorded following teaching course and a standard teaching course in the manner of double-window or multi-window on the same screen or in the manner of multi-screen synchronous display, thereby realizing intuitive comparison.

The split-screen comparison presentation unit can also perform the following functions: the comparison of the pre-class test analysis results, the comparison between the suggested lecturing time and the actual lecturing time, the comparison of similarity between the information about following voice text and the information about standard voice text, and/or the comparison of in-class practice test results.

The following teaching analysis unit further comprises:

an improvement suggestion generation unit for giving, during split-screen comparison presentation, information about an evaluation and an improvement suggestion for each of the stages during following teaching according to the knowledge point-based association relationship, which is determined according to the relational database, among various types of data in conjunction with the comparison results.

The following teaching analysis unit further comprises:

a following degree calculation unit for calculating a following coefficient Fₙ for each following teaching, and making multiple following coefficients Fₙ, in a certain period into a following coefficient change curve and presenting same to the following teacher, wherein the formula for calculating the following coefficient is:

$${F}_{n} = 1 - ( α ( {\sum }_{1}^{n} {δ}_{1} ( \frac{\vert {ST}_{1} - {PT}_{1} \vert}{{ST}_{1}} ) + … + {δ}_{i} ( \frac{\vert {ST}_{i} - {PT}_{i} \vert}{{ST}_{i}} ) ) + β ( \frac{\vert E 1 - E 2 \vert}{E 2} ) + γ ( \frac{\vert S 1 - S 2 \vert}{S 2} ) )$$

where

STᵢ represents a suggested lecturing time of a knowledge point i, PTᵢ represents an actual lecturing time of the knowledge point i, i=1, 2 . . . n, n being a positive integer and used for representing the number of knowledge points, and δrepresents a weight coefficient for an ith knowledge point, where δ₁+ . . . +δᵢ=1;

E1 represents evaluation data for the teaching of the following teacher, E2 represents evaluation data for the teaching of the standard teacher, the evaluations are usually given by the student over the Internet teaching platform, and the two pieces to of evaluation data adopt the same standard;

S1 represents an average score for all in-class practice in a following class, and S2 represents an average score for all in-class practice in a standard class; and

α, β, γ are used as balance coefficients, α+β+γ=1, the value of α is 0.30-0.50, the value of β is 0.10-0.30, and the value of γ is 0.20-0.40.

The following voice evaluation unit comprises an input voice acquisition unit, a voice segment division unit, a temperament feature acquisition unit, a to-be-evaluated content determination unit, a standard voice generation unit, a voice comparison and analysis unit, and a comparison result generation unit, wherein

the input voice acquisition unit is used for acquiring voice data of the following teacher from the following teaching recorded and broadcast data in the following teaching recording unit;

the voice segment division unit is used for performing basic voice segment division on the voice data, so as to obtain a voice unit sequence of the voice data;

the temperament feature acquisition unit is used for performing feature extraction on the voice unit sequence, so as to acquire a temperament feature of the voice unit sequence;

the to-be-evaluated content determination unit is used for performing feature calculation on the extracted temperament feature, and using, if a calculation result satisfies a predetermined condition, a vocal unit that meets the condition as to-be-evaluated content;

the voice comparison and analysis unit is used for acquiring a temperament feature of the to-be-evaluated content, and performing comparison and analysis on the temperament feature and a standard teaching voice of the standard voice generation unit; and

the comparison result generation unit is used for marking a voice evaluation result on voice text of the following teacher and providing same to the following teacher.

The standard voice generation unit is used for recognizing and converting the voice data of the following teacher into information about voice text, and then generating a standard teaching voice of the following teacher by using a standard pronunciation database according to the information about voice text.

The conversion of the voice text of the following teacher can be performed by the voice recognition and conversion unit of the following teaching analysis unit.

The basic voice unit may be a syllable, a phoneme or the like, and basic voice units of the voice data and a sequence of voice units are obtained by dividing the voice.

The temperament feature of the sequence of voice units comprises a prosodic feature and a syllable feature.

The prosodic feature comprises a boundary feature and pronunciation time length of each basic voice unit, a pause time between adjacent basic voice units, and a pronunciation time length of the entire sequence of voice units.

The syllable feature comprises the pronunciation of each of the basic voice units.

The calculation of the temperament features of the sequence of voice units by the to-be-evaluated content determination unit can be performed by using a method for calculating an optimal score path, which comprises:

using a trained acoustic model for the extracted temperament features of the sequence of voice units, so as to calculate an optimal score path; and

if the optimal score path contains to-be-evaluated content to be detected, determining that the to-be-evaluated content has been detected.

The formula for calculating the optimal score path is:

$$W = {arg max}_{W} P ( W ) P ( X \vert W )$$

where

X represents a vector of the temperament feature of the sequence of voice units, and W represents an optimal sequence of words with the highest score;

a conditional probability P(X|W) is an acoustic model score, which is obtained, by means of calculation, by using the trained acoustic model; and

a prior probability P(W) is a language model score, which is the penalty applied to different acoustic models.

The temperament feature of the to-be-evaluated content may further comprise a temperament feature of context content of the to-be-evaluated content.

An operation of the voice comparison and analysis unit performing voice evaluation by using a voice prediction model comprises:

performing basic voice segment division on a recorded user voice;

extracting, from the sequence of voice units, corresponding to-be-evaluated temperament features;

loading corresponding prediction models for different temperament features, so as to predict corresponding standard pronunciations; and

comparing temperament features of the user voice with temperament features of standard pronunciations, so as to obtain corresponding evaluation results.

The present invention forms, by relying on the Internet teaching platform and taking the teaching recording and broadcasting system as the main means of realization, a standard teaching recorded and broadcast course with segmentation features by performing standardization and modular segmentation processing on the class teaching process, and on this basis, while a following teacher conducts local following teaching, the present invention tests students' master of basic knowledge, compares the test results between the following teaching and a standard class, provides the guidance of a suggested lecturing time for the following teacher in conjunction with a lecturing time for knowledge points in a standard course, and records and compares the actual execution conditions. In order to further reflect the characteristics of following teaching, after the completion of a following class so as to form a following teaching recorded and broadcast course, the present invention comparatively presents, in the manner of multi-window on the same screen or in the manner of multi-screen synchronous display, the differences and similarities between the following teaching and the standard teaching to the following teacher, provides data support, including similarity of voice text, generation of an improvement suggestion, the calculation of a following degree, etc., and can also evaluate the pronunciation of the following teacher, so as to be able to provide more effective data support for following teaching and facilitate improving the efficiency of following teaching and the effect of following teaching.

The additional aspects and advantages of the present invention will be partly presented in the following description, partly become apparent in the following description or be appreciated through the embodiments or examples of the present invention.

### BRIEF DESCRIPTION OF THE DRAWINGS

In order to illustrate the technical solutions in embodiments of the present invention more clearly, the accompanying drawing used in the description of the embodiments of the present invention will be briefly introduced hereinbelow; and apparently, the accompanying drawing illustrates only some embodiments of the present invention, and a person skilled in the art can also derive other drawings according to the contents of the embodiments of the present invention and these drawings without any inventive effort.

FIG. 1 is a schematic diagram of an architecture of an Internet teaching platform of the present invention;

FIG. 2 is a schematic diagram of main units of a following teaching system of the present invention;

FIG. 3 is a schematic diagram of subunits of a standard course forming unit of the present invention;

FIG. 4 is a schematic diagram of subunits of a following teaching recording unit of the present invention;

FIG. 5 is a schematic diagram of subunits of a following teaching analysis unit of the present invention; and

FIG. 6 is a schematic diagram of subunits of a following voice evaluation unit of the present invention.

### DETAILED DESCRIPTION OF EMBODIMENTS

The detailed description of the present invention will be further described in detail below in conjunction with the drawings.

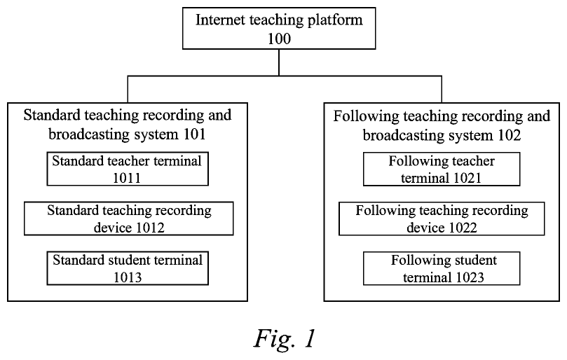

FIG. 1 is a schematic diagram of an architecture of an Internet teaching platform of the present invention. As shown in FIG. 1, the Internet teaching platform 100 comprises a standard teaching recording and broadcasting system 101 and a following teaching recording and broadcasting system 102. The standard teaching recording and broadcasting system 101 comprises a standard teacher terminal 1011, a standard teaching recording device 1012 and a standard student terminal 1013. The following teaching recording and broadcasting system 102 comprises a following teacher terminal 1021, a following teaching recording device 1022 and a following student terminal 1023. The standard teaching recording and broadcasting system 101 and the following teaching recording and broadcasting system 102 may further specifically comprise various image, sound and operation action collection devices.

The terminal of the present invention comprises: a processor, a network module, a control module, a display module and an intelligent operating system. The terminal can be provided with a variety of data interfaces for connecting to various extension devices and accessories via a data bus. The intelligent operating system comprises Windows, Android and its improvements, and iOS, on which application software can be installed and run, and the functions of various types of application software, services, and application program stores/platforms under the intelligent operating system are realized.

The terminal of the present invention can be connected to the Internet by using a connection mode of RJ45/Wi-Fi/Bluetooth/2G/3G/4G/G.hn/Zigbee/Z-ware/RFID, etc., and can be connected to other terminals or other computers and devices via the Internet. By using a variety of data interfaces or bus modes, such as 1394/USB/serial/SATA/SCSI/PCI-E/Thunderbolt/data card interface, and by using a connection mode like an audio and video interface, such as HDMI/YpbPr/SPDIF/AV/DVI/VGA/TRS/S CART/Displayport, various extension devices and accessories are connected to constitute a conference/teaching device interaction system. The functions of acoustic control and shape control are realized by using a sound capture control module and a motion capture control module in the form of software, or by using a sound capture control module and a motion capture control module in the form of data bus on-board hardware. The display, projection, voice access, audio and video playing, as well as digital or analog audio and video input and output functions are realized by connecting to a display/projection module, a microphone, a sound device and other audio and video devices via audio and video interfaces. The image access, sound access, use control and screen recording of an electronic whiteboard, and an RFID reading function are realized by connecting to a camera, a microphone, the electronic whiteboard and an RFID reading device via data interfaces, and a mobile storage device, a digital device and other devices can be accessed and managed and controlled via corresponding interfaces. The functions including manipulation, interaction and screen shaking between multi-screen devices are realized by means of DLNA/IGRS technologies and Internet technologies.

In the present invention, the processor is defined to include but not limited to: an instruction execution system, such as a computer/processor-based system, an application specific integrated circuit (ASIC), a computing device, or a hardware and/or software system capable of fetching or acquiring logic from a non-transitory storage medium or a non-transitory computer readable storage medium and executing instructions contained in the non-transitory storage medium or the non-transitory computer readable storage medium. The processor may further comprise any controller, state machine, microprocessor, Internet-based entity, service or feature, or any other analog, digital, and/or mechanical implementation thereof.

In the present invention, the computer readable storage medium is defined to include but not limited to: any medium capable of containing, storing or maintaining programs, information and data. The computer readable storage medium comprises any of many physical media, such as an electronic medium, a magnetic medium, an optical medium, an electromagnetic medium or a semiconductor medium. More specific examples of memories suitable for the computer readable storage medium and the terminal and server include but not limited to: a magnetic computer disk (such as a floppy disk or a hard drive), a magnetic tape, a random access memory (RAM), a read only memory (ROM), an erasable programmable read only memory (EPROM), a compact disk (CD) or digital video disk (DVD), Blu-ray memory, a solid state disk (SSD), and a flash memory.

In the present invention, the Internet can comprise a local area network and wide area Internet, may be wired Internet or may be wireless Internet, or may be any combination of these networks.

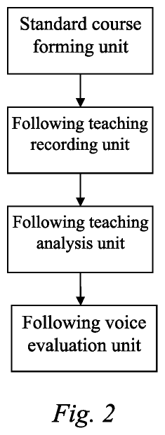

As shown in FIG. 2, according to the specific embodiments of the Internet teaching platform-based following teaching system of the present invention, the Internet teaching platform has a class teaching recording function, and the following teaching system comprises the following units: a standard course forming unit, a following teaching recording unit, a following teaching analysis unit, and a following voice evaluation unit.

The standard course forming unit is used for collecting standard class teaching data of a standard teacher by using a standard teaching recording and broadcasting system of the Internet teaching platform, and processing the class teaching data in segments, for example, in a pre-class test stage, a class lecturing stage and an in-class practice stage, wherein each of the stages is identified and distinguished by using information about a time identifier, and the time identifier is saved together with the standard class teaching data so as to constitute standard teaching recorded and broadcast data, thereby forming a standard teaching recorded and broadcast course.

The internet teaching platform may be a variety of available Internet teaching platforms that have access to the Internet, have an interaction function and have the function of recording the class teaching process. Such Internet teaching platforms generally comprise a teacher terminal, a student terminal, a multimedia teaching device, a class teaching recording device, and a local or cloud server, and these devices are communicatively connected to one another via wired or wireless, local area or wide area Internet, etc.

The standard teaching recording and broadcasting system can be communicatively connected to the Internet teaching platform, such that class teaching data, such as image data, audio data and motion data (for example, data of operation actions, such as a teaching terminal operation action, an electronic whiteboard operation action, and a drawing action of a drawing board) can be respectively collected by using a recording device, such as an image collection device, an audio collection device and/or an operation action collection device, and moreover, statistical analysis can be performed on other real-time data generated during the teaching process and processing, such as storing and uploading, can be performed on a variety of obtained data.

Preferably, these pieces of recorded and broadcast data can be saved, in the form of data streams, to a local storage device, a server storage device of the Internet teaching platform, or a cloud storage device connected to the server, such as a disk storage array.

The so-called standard teacher refers to such a teacher whose teaching recorded and broadcast course for class teaching is used as a standard teaching recorded and broadcast course, and is learned and referenced by a following teacher or recommended to a following teacher for learning and reference, such that the following teacher performs local class teaching by taking same as a reference standard for imitative following teaching.

The standard teaching recorded and broadcast course can be shared on a platform over the Internet, such that a user who logs in to the teaching platform via the Internet can obtain same for operations of downloading, browsing, learning, etc.

The segmentation processing means that the class teaching process can be divided into a pre-class test stage, a class lecturing stage and an in-class practice stage, and these three stages generally have a sequentially logical relationship in terms of a time order. These three stages are segmented and identified by time identifiers, such as time stamps.

On the basis of these three stages, similar subdivision segmentation processing can be continued for the class teaching process, and each of the three stages, especially the class lecturing stage, can also be further divided into multiple sub-segments, for example, dividing the class lecturing stage into several lecturing sub-segments according to different knowledge points for lecturing.

During sub-stages and sub-segments, a relational database, with knowledge points serving as associated points or ties, is gradually established, such that an association relation, with knowledge points serving as key points or ties, is established among exercises in the pre-class test stage, the lecturing of knowledge points in the class lecturing stage, and exercises in in-class practice, and the association relation is saved to a relational database.

The division of these stages and sub-segments is preferably performed by segmenting and identifying (distinguishably identifying) same with time identifiers, with the knowledge points serving as linking ties, which generally does not need to cut and segment data.

The following teaching recording unit is used for collecting following class teaching data of a following teacher by using a following teaching recording and broadcasting system of the Internet teaching platform, analyzing pre-class test result data of the following class teaching data in real time, comparing the results analyzed in real time with corresponding data of the standard teaching recorded and broadcast data, providing a suggested lecturing time for the class lecturing stage of the following teacher, and recording the suggested lecturing time and an actual lecturing time. The suggested lecturing time and the actual lecturing time are saved together with the following class teaching data so as to constitute following teaching recorded and broadcast data, thereby forming a following teaching recorded and broadcast course. For the other data that may be involved in a teaching or following process, it may be uniformly identified by using, for example, identifiers of time stamps and then stored separately or stored together with the teaching recording and broadcasting data according to the storage mode for the other data.

Preferably, the suggested lecturing time can be displayed on the screen of a terminal of the following teacher terminal in a manner of a time prompt, such that the following teacher reasonably controls the teaching progress according to the time prompt.

The so-called following teacher is a teacher who imitates or follows the teaching recorded and broadcast course of the standard teacher to perform local class teaching. The following teaching recorded and broadcast course can also be shared on the platform over the Internet, but the following teacher can also choose not to upload same to the Internet teaching platform, or choose to upload same to the Internet teaching platform, but only for the downloading, browsing, learning, etc. by students within a certain range, such as students of this class or this school, that is to say, the following teaching recorded and broadcast course can be shared in levels according to the will of the following teacher.

The following teaching recording and broadcasting system and the standard teaching recording and broadcasting system for the standard course may be the same, or may be different, as long as it is ensured that the class recorded and broadcast data with the same standard or resolution can be obtained.

It is preferred that the recording and broadcasting system used by the standard teacher and the recording and broadcasting system used by the following teacher use devices of the same model, and it is particularly preferred that the manner in which these devices are mounted in the classroom remain consistent, such that the data collected by the recording and broadcasting system remain consistent in terms of technical parameters.

Teaching recorded and broadcast data of the following teacher can also be respectively saved, in the form of data streams, to a local storage device, a storage device of a server, or a cloud storage device connected to the server, such as a disk storage array. The teaching recorded and broadcast data of the following teacher can remain consistent with that of the standard teacher, which will not be described again herein.

The following teaching analysis unit is used for analyzing the following teaching recorded and broadcast data ex post facto, comparing same with the standard teaching recorded and broadcast data in segments, including the comparison between the suggested lecturing time and the actual lecturing time in each of the stages, and the comparison of information about voice text in each of the stages, and synchronously playing back the following teaching recorded and broadcast course and the standard teaching recorded and broadcast course and displaying same to the following teacher.

The processing of comparison may be performed by a local server, and the data may be submitted to a cloud for analysis and comparison by dedicated cloud computing centers, which may be a company providing commercial services.

Optionally, all the operations, such as comparison and analysis, are performed by a local server or computer device.

The following voice evaluation unit is used for comparing a teaching voice of the following teacher with a standard teaching voice and marking a comparison result on voice text of the following teacher.

The following voice evaluation unit comprises an input voice acquisition unit, a voice segment division unit, a temperament feature acquisition unit, a to-be-evaluated content determination unit, a standard voice generation unit, a voice comparison and analysis unit, and a comparison result generation unit, wherein

the input voice acquisition unit is used for acquiring voice data of the following teacher from the following teaching recorded and broadcast data in the following teaching recording unit;

the voice segment division unit is used for performing basic voice unit division on the voice data, so as to obtain a voice unit sequence of the voice data;

the temperament feature acquisition unit is used for performing feature extraction on the voice unit sequence, so as to acquire a temperament feature of the voice unit sequence;

the to-be-evaluated content determination unit is used for performing feature calculation on the extracted temperament feature, and using, if a calculation result satisfies a predetermined condition, a vocal unit that meets the condition as to-be-evaluated content;

the voice comparison and analysis unit is used for acquiring a temperament feature of the to-be-evaluated content, and performing comparison and analysis on the temperament feature and a standard teaching voice of the standard voice generation unit; and

the comparison result generation unit is used for marking a voice evaluation result on voice text of the following teacher and providing same to the following teacher.

The standard voice generation unit is used for recognizing and converting the voice data of the following teacher into information about voice text, and then generating a standard teaching voice of the following teacher by using a standard pronunciation database according to the information about voice text.

The conversion of the voice text of the following teacher can be performed by the voice recognition and conversion unit of the following teaching analysis unit.

The basic voice unit may be a syllable, a phoneme or the like, and basic voice units of the voice data and a sequence of voice units are obtained by dividing the voice.

The temperament feature of the sequence of voice units comprises a prosodic feature and a syllable feature.

The prosodic feature comprises a boundary feature and pronunciation time length of each basic voice unit, a pause time between adjacent basic voice units, and a pronunciation time length of the entire sequence of voice units.

The syllable feature comprises the pronunciation of each of the basic voice units.

The calculation of the temperament features of the sequence of voice units by the to-be-evaluated content determination unit can be performed by using a method for calculating an optimal score path, which comprises:

using a trained acoustic model for the extracted temperament features of the sequence of voice units, so as to calculate an optimal score path; and

if the optimal score path contains to-be-evaluated content to be detected, determining that the to-be-evaluated content has been detected.

The formula for calculating the optimal score path is:

W=_{W}^{arg max P(W)P(X|W)}

where

X represents a vector of the temperament feature of the sequence of voice units, and W represents an optimal sequence of words with the highest score;

a conditional probability P(X|W) is an acoustic model score, which is obtained, by means of calculation, by using the trained acoustic model; and

a prior probability P(W) is a language model score, which is the penalty applied to different acoustic models.

The temperament feature of the to-be-evaluated content may further comprise a temperament feature of context content of the to-be-evaluated content.

An operation of the voice comparison and analysis unit performing voice evaluation by using a voice prediction model comprises:

performing basic voice segment division on a recorded user voice;

extracting, from the sequence of voice units, corresponding to-be-evaluated temperament features;

loading corresponding prediction models for different temperament features, so as to predict corresponding standard pronunciations; and

comparing temperament features of the voice of the following teacher with temperament features of standard pronunciations, so as to obtain corresponding evaluation results.

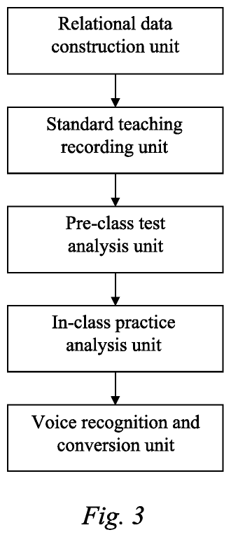

As shown in FIG. 3, the standard course forming unit specifically comprises: a relational data construction unit, a standard teaching recording unit, a pre-class test analysis unit, an in-class practice analysis unit and a voice recognition and conversion unit.

The relational data construction unit is used for dividing knowledge points of a class syllabus of each standard course, generating keywords by using the knowledge points as data items and according to the knowledge points, establishing a correlation between the keywords and the knowledge points, and establishing, on the basis of the data items and according to the comparison of information about attributes between exercises in a pre-class test and exercises in in-class practice, an association relationship, which takes the knowledge points as associated points, among various types of data, thereby constructing a relational database.

The division of the knowledge points comprises three steps:

step I: dividing the class syllabus into basic knowledge and newly lectured knowledge to serve as a first-level data item;

step II: further dividing the basic knowledge into several basic knowledge points, and further dividing the newly lectured knowledge into several newly lectured knowledge points to serve as a second-level data item;

and step III: based on the association relationship between the basic knowledge points and the newly lectured knowledge points, further improving the data structure of the relational database.

Preferably, the relational database is independently saved as a constituent part of the standard teaching recorded and broadcast data.

Preferably, during the process of a standard teacher conducting class teaching, which herein mainly refers to during the process of course lecturing, including the lecturing of basic knowledge (usually retrospective lecturing) and the lecturing of newly lectured knowledge, a correlation between knowledge or knowledge points and a duration for recorded and broadcast data is established, wherein the duration is divided by a time identifier, preferably information about a time stamp, and is saved to the relational database.

For example, during the class lecturing of the basic knowledge, a correlation between the basic knowledge and a duration for the standard recorded and broadcast data is established.

Preferably, a correlation between the basic knowledge points and a sub-duration for the standard recorded and broadcast data is further established, wherein the sub-duration is further subdivision of the duration for the recorded and broadcast data. The division of the duration or sub-duration of the recorded and broadcast data may be manually clicked on for confirmation by the standard teacher during class lecturing, or may be divided according to the searching of keywords or manual distinguishing ex post facto.

That is to say, after the completion of the standard teaching recording process, a relational database, with the knowledge or knowledge points serving as an association identifier, for “data entries for class teaching target-exercises in a pre-class test-segmented data in class lecturing-exercises in in-class practice” can be formed, such that segment division can be performed on the standard teaching recorded and broadcast course and a contextual correlation can be established.

The standard teaching recording unit is used for collecting the class teaching data by using a teaching recording device of a standard teaching recording and broadcasting system, for example, respectively collecting image data, audio data and motion data by using an image collection device, an audio collection device and/or a motion collection device, wherein these pieces of data can be respectively saved in the form of data streams and can be time stamped by a time stamp.

The pre-class test analysis unit is used for performing real-time analysis on test results of a basic knowledge test conducted by a student over a student terminal after the start of class teaching and before the class lecturing stage, so as to form pre-class test result analysis data for knowing about the current student's mater of related basic knowledge, preferably basic knowledge points, thereby becoming more targeted in the subsequent class lecturing, and thus facilitating the subsequent conducting of standard teaching.

The test analysis data can not only be provided in real time, for example, presented to a standard teacher, but also can be saved separately, and preferably, saved together as a constituent part of the standard teaching recorded and broadcast data.

The in-class practice analysis unit is used for performing real-time analysis on test results of an in-class practice test conducted by a student over a student terminal before the end of class teaching and after the class lecturing stage, so as to form in-class practice result analysis data for knowing about the student's mater of newly lectured knowledge, preferably the mater of newly lectured knowledge points, thereby providing technical support for the self-analysis of the teaching process by a teacher, and thus facilitating the teacher in knowing about the teaching effect.

The in-class practice analysis data can not only be provided in real time, for example, presented to a standard teacher, but also can be saved separately, and preferably, saved together as a constituent part of the standard teaching recorded and broadcast data.

The voice recognition and conversion unit is used for converting audio data of the class teaching data into information about standard voice text by using a voice recognition technology, and counting word frequency numbers of keywords in information about standard voice text corresponding to each of the knowledge points. Preferably, the information about standard voice text comprises information about a time identifier of original audio data, such as preferably information about a time stamp, such that a correlation between voice text and the audio data can be established based on the information about a time identifier.

Preferably, the information about standard voice text with the information about a time identifier is saved together as a constituent part of the standard teaching recorded and broadcast data, and is displayed on a terminal device in the form of subtitles during on-demand playback.

Preferably, the data entries in the relational data construction unit comprise a correlation between knowledge or knowledge points and a duration for recorded and broadcast data (divided based on a time identifier, preferably information about a time stamp), and the information about standard voice text is divided and a correlation with the knowledge or knowledge points is established and saved together as a constituent part of the standard teaching recorded and broadcast data.

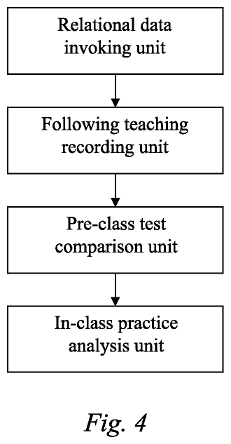

As shown in FIG. 4, the following teaching recording unit specifically comprises: a relational data invoking unit, a following teaching recording unit, a pre-class test comparison unit and an in-class practice analysis unit.

The relational data invoking unit is used for retrieving the relational database at the beginning of following class teaching, so as to provide data support for the following unit, and the relational database may be retrieved before or at the starting of the following class teaching, as long as the execution of the following teaching process is not delayed.

The following teaching recording unit is used for collecting the following class teaching data by using a teaching recording device of a following teaching recording and broadcasting system, for example, respectively collecting image data, audio data and motion data by using an image collection device, an audio collection device and/or a motion collection device, wherein these pieces of data can be respectively saved in the form of data streams and can be time stamped by a time stamp.

These recording devices preferably remain the same model as that of the previous corresponding devices, preferably being also the same or similar in terms of the mounting mode thereof in classroom, such as the orientation of the image collection device, the distance between an audio collection device and a lecturer, and the setting of an electronic whiteboard.

The pre-class test comparison unit is used for performing real-time analysis on test results of a basic knowledge test conducted by a student over a student terminal after the start of following class teaching and before a following class lecturing stage so as to form pre-class test result analysis data, comparing the pre-class test analysis result with a pre-class test analysis result of a standard course, providing, to the following teacher, the student's master of the basic knowledge points as well as the difference between the student and a student in a standard class, and giving a suggested lecturing time concerning the knowledge points according to the difference and information about an association of the knowledge points in the relational database in conjunction with a lecturing time for the knowledge points in standard class.

Preferably, according to the weight of the association between the basic knowledge points and the newly lectured content, the current suggested following lecturing time is given according to the standard lecturing time.

Preferably, information about a time prompt is generated and presented on a teacher terminal, making it convenient for the following teacher to control the teaching progress in class lecturing.

The in-class practice analysis unit is used for performing real-time analysis on test results of an in-class practice test conducted by a student over a student terminal before the end of class teaching and after the class lecturing stage, so as to form in-class practice result analysis data for knowing about the student's mater of newly lectured content, thereby facilitating the standard teacher in knowing about the teaching effect. The exercises in the in-class practice are consistent with those in a standard teaching process.

The in-class practice analysis data may be saved separately, or saved together with the teaching recorded and broadcast data as affiliated data.

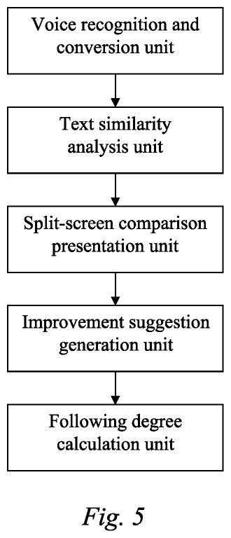

As shown in FIG. 5, the following teaching analysis unit specifically comprises: a voice recognition and conversion unit, a text similarity analysis unit, a split-screen comparison presentation unit, an improvement suggestion generation unit and a following degree calculation unit.

The voice recognition and conversion unit is used for converting audio data of the following teaching recorded and broadcast data into information about voice text by using a voice recognition technology, and counting word frequency numbers of keywords in information about voice text corresponding to each of the knowledge points, wherein the keywords are consistent with keywords in a standard course.

Preferably, the information about voice text with the information about a time identifier is saved together as a constituent part of the following teaching recorded and broadcast data, and is displayed on a terminal device in the form of subtitles during on-demand playback.

Preferably, according to the correlation between knowledge or knowledge points and a duration for recorded and broadcast data (divided based on a time identifier, preferably information about a time stamp), the information about voice text is divided, and a correlation with the knowledge or knowledge points is established and is saved together as a constituent part of the following teaching recorded and broadcast data. The correlation between knowledge points and a voice is defined or differentiated according to a time stamp, or is differentiated. The specific correspondence may be recognized or marked by a teacher by means of a click-on confirmation operation during the recording process, or may be automatically confirmed by means of the searching of keywords and then is manually confirmed, etc.

The text similarity analysis unit is used for performing comparative analysis on the word frequency numbers of the keywords corresponding to each of the knowledge points in the information about standard voice text and the word frequency numbers of the keywords corresponding to each of the knowledge points in the information about following voice text, so as to determine the similarity between the information about following voice text and the information about standard voice text.

There are many specific text similarity algorithms in the prior art, such as a comparison technique for academic paper anti-plagiarism. The use of different algorithms will generate slight difference in terms of the obtained similarity coefficients however, the similarity coefficient should not be too low or too high. The present invention adopts a conventional paper similarity comparison algorithm, and the preferred similarity coefficient is between 0.20 to 0.68.

The setting of the similarity coefficient is given on the basis of a great quantity of statistical data. The selection of the similarity coefficient within this range generally cannot only ensure that knowledge points cannot missed during class lecturing, but also can maintain the independence and freedom of the expression of the following teacher, because if the similarity coefficient is too high, an impression of a similarly completely imitative teaching, such as talking like a parrot will be given to people, which is not conducive to the growth and self-awareness stimulation of the following teacher, and if the similarity coefficient is too low, the following teacher may face the problem of insufficient lecturing of the knowledge points.

Preferably, knowledge points-based voice text is compared in segments according to the correlation, determined by the relational database, between the information about voice text and the knowledge or knowledge points, so as to more accurately determine the similarity coefficients of the two voice text.

The split-screen comparison presentation unit is used for simultaneously presenting, to the following teacher, the recorded following teaching course and a standard teaching course in the manner of double-window or multi-window on the same screen or in the manner of multi-screen synchronous display, thereby realizing intuitive comparison. The split-screen comparison presentation unit may also be further used for performing: the comparison of the pre-class test analysis results, the comparison between the suggested lecturing time and the actual lecturing time, the comparison of similarity between the information about following voice text and the information about standard voice text, and/or the comparison of in-class practice test results.

The comparison specifically comprises the comparison between the related analysis data of each stage and sub-stage, such as the comparison of statistical analysis in the pre-class test stage, and the comparison between the suggested lecturing time and actual lecturing time for the knowledge points given on this basis, the comparison of similarity coefficients of voice text in each stage and sub-stage, and the comparison of test results of in-class practice.

The improvement suggestion generation unit is used for giving, during split-screen comparison presentation, information about an evaluation and an improvement suggestion for each of the stages during following teaching according to the knowledge point-based association relationship, which is determined according to the relational database, among various types of data in conjunction with the analysis results of pre-class test, class lecturing and in-class practice.

Preferably, the evaluation information and the improvement suggestion are selected by the following teacher in an optional manner according to the self-evaluation combined with the analysis results.

Preferably, the following teacher can input the evaluation information and the improvement suggestion after viewing the comparison.

Preferably, the evaluation information and the improvement suggestion confirmed or input by the following teacher are saved, by means of the association relationship with each of the stages and sub-stages, to the following teaching recorded and broadcast data as a part of the following recorded and broadcast data.

The following degree calculation unit is used for calculating a following coefficient Fₙ for each following teaching, and making multiple following coefficients Fₙ in a certain period into a following coefficient change curve and presenting same to the following teacher.

The following coefficient is mainly obtained, by means of calculation according to the following formula, by taking related data of the standard teacher as the basis for original comparison, wherein the related data used may comprise: a suggested lecturing time STᵢ and an actual lecturing time PTᵢ of the following teacher for a knowledge point i, data of evaluation E1 on the lecturing of the following teacher and data of evaluation E2 on the lecturing of the standard teacher, and an average score S1 for each in-class practice in following class and an average score S2 for each in-class practice in standard class. The following coefficient can reflect, to some extent, the current growth degree of the following teacher, the acceptability of the student and the degree of improvement of the teaching effect.

The formula for calculating the following coefficient is:

$${F}_{n} = 1 - ( α ( {\sum }_{1}^{n} {δ}_{1} ( \frac{\vert {ST}_{1} - {PT}_{1} \vert}{{ST}_{1}} ) + … + {δ}_{i} ( \frac{\vert {ST}_{i} - {PT}_{i} \vert}{{ST}_{i}} ) ) + β ( \frac{\vert E 1 - E 2 \vert}{E 2} ) + γ ( \frac{\vert S 1 - S 2 \vert}{S 2} ) )$$

where

STᵢ represents a suggested lecturing time of a knowledge point i, PTᵢ represents an actual lecturing time of the knowledge point i, i=1, 2 . . . n, n being a positive integer and used for representing the number of knowledge points, and δrepresents a weight coefficient for an ith knowledge point, where δ₁+ . . . +δᵢ=1;

E1 represents evaluation data for the teaching of the following teacher, E2 represents evaluation data for the teaching of the standard teacher, the evaluations are usually given by the student over the Internet teaching platform, and the two pieces of evaluation data adopt the same standard;

S1 represents an average score for all in-class practice in a following class, and S2 represents an average score for all in-class practice in a standard class; and

α, β, γ are used as balance coefficients, α+β+γ=1, which can be set according to actual needs, and after a great quantity of data statistics and analysis, it is preferable that the value of α is 0.30-0.50, the value of β is 0.10-0.30, and the value of γ is 0.20-0.40. For following teaching, the value range can reflect the core of the following teaching and can also take into account the student's reflection and actual effect, and can better balance the relationship of these factors.

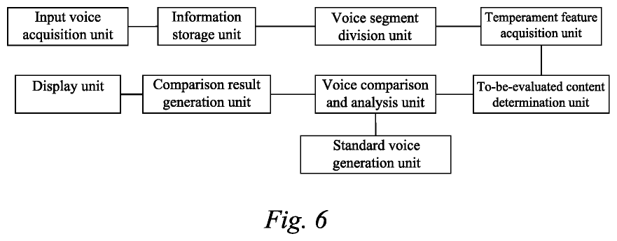

FIG. 6 is a schematic diagram of subunits of a following voice evaluation unit of the present invention.

After the completion of the following teaching process, the following teacher can acquire voice data, in the following teaching recorded and broadcast data, of the following teacher by using the following teaching recording unit. The following voice evaluation unit compares the voice of the following teacher with the standard voice, especially the part of those focused knowledge points for explanation, thereby providing the following teacher with a voice evaluation reference for self-pronunciation. The voice evaluation unit of the present invention comprises an input voice acquisition unit, an information storage unit, a voice segment division unit, a temperament feature acquisition unit, a to-be-evaluated content determination unit, a standard voice generation unit, a voice comparison and analysis unit, a comparison result generation unit, a display unit and a voice prediction model.

According to the voice evaluation unit of the present invention, the input voice acquisition unit is used for acquiring a voice input by a user and storing the voice data to the information storage unit. Preferably, the voice data may be voice data, of the follow teacher, obtained by using the following teaching recording unit. Optionally, the voice collection device is separately arranged to specifically collect the voice data, of the following teacher, used for voice evaluation. After the learning and studying of the teaching process of the standard teacher and during the process of conducting following teaching, the following teacher specially pays attention to whether the process of explaining a certain knowledge point is clear and whether the pronunciation is accurate, and certainly may also pay attention to the whole voice process.

The voice segment division unit is used for performing basic voice segment division on the recorded voice by a user. The basic voice unit may be a syllable, a phoneme or the like, and basic voice units of the voice data and a sequence of voice units are obtained by dividing the voice.

Different voice recognition systems will be based on different acoustic features, such as an MFCC (Mel-Frequency Cepstrum Coefficients) feature-based acoustic model, and a PLP (Perceptual Linear Predictive) feature-based acoustic model, or uses different acoustic models, such as an HMM-GMM (Hidden Markov Model-Gaussian Mixture Model), neural network acoustic model, a DBN (Dynamic Beyesian Network)-based neural network acoustic model, etc., or uses different decoding modes, such as Viterbi searching and A* searching, for decoding voice signals.

The temperament feature acquisition unit is used for analyzing the voice unit sequence, so as to acquire a temperament feature of the voice unit sequence.

The temperament feature comprises a prosodic feature and a syllable feature, wherein the prosodic feature comprises a boundary feature and pronunciation time length of each basic voice unit, a pause time between adjacent basic voice units, and a pronunciation time length of the entire sequence of voice units. The syllable feature comprises the pronunciation of each of the basic voice units.

The to-be-evaluated content determination unit is used for performing feature calculation on the extracted temperament feature, and using, if a calculation result satisfies a predetermined condition, a vocal unit that meets the condition as to-be-evaluated content. The so-called to-be-evaluated content can be selected or set according to information, such as the knowledge points and keywords lectured in a lecture. For example, in the process of lecturing a physical concept, the core content or points can be used as the focused to-be-evaluated content. For English learning, the to-be-evaluated content may be focused English words, phrases, and so on.

The calculation of the temperament feature can adopt the method for calculating an optimal score path, which comprises: using a trained acoustic model for the extracted temperament features so as to calculate an optimal score path, and if the optimal score path contains to-be-evaluated content to be detected, determining that the to-be-evaluated content has been detected. The formula for calculating the optimal score path is:

$$W = {arg max}_{W} P ( W ) P ( X \vert W )$$

where X represents a vector of the temperament feature of the sequence of voice units, and W represents an optimal sequence of words with the highest score; a conditional probability P(X|W) is an acoustic model score, which is obtained, by means of calculation, by using the trained acoustic model; and a prior probability P(W) is a language model score, which is the penalty applied to different acoustic models. The voice comparison and analysis unit is used for acquiring a temperament feature of the to-be-evaluated content, and performing comparison and analysis on the temperament feature and a standard voice predicted by a voice prediction model.

The voice comparison and analysis unit acquires a temperament feature of the to-be-evaluated content, for example, acquiring a temperament feature of a certain word or phrase. Comparison and analysis are performed on the temperament feature and the standard voice predicted by the voice prediction model, so as to give the result of evaluation, from the user, regarding the to-be-evaluated content.

In order to further know about the fluency of a user reading the to-be-evaluated content, the temperament feature may further comprise a temperament feature of context content of the to-be-evaluated content.

The existing voice evaluation technology can be used in the method for performing voice evaluation by using a voice prediction model, that is, performing basic voice segment division on a recorded user voice; extracting, from a sequence of voice units, corresponding to-be-evaluated temperament features; loading corresponding prediction models for different temperament features, so as to predict corresponding standard pronunciations; and then comparing temperament features of the user voice with temperament features of standard pronunciations, so as to obtain corresponding evaluation results.

The comparison result generation unit is used for marking a voice comparison result on voice text of a user and providing same to the user.

In order to mark the text read by the user, the comparison result generation unit acquires the voice evaluation result given by the voice comparison and analysis unit, marks same on the text read by the user in a visual manner, and displays same to the user through the display unit. By means of the displayed evaluation results, the user knows whether the pronunciation of the newly learned content in the entire paragraph is accurate and smooth.

Preferred embodiments of the present invention introduced above are intended to make the spirit of the present invention more apparent and easy to understand, but not to limit the present invention. Any modifications, replacements and improvements made within the spirit and principles of the present invention should be regarded as within the scope of protection of the claims of the present invention.

### INDUSTRIAL APPLICABILITY

By using the system of the present invention to perform processing of relationship construction, statistics, analysis and comparison on a variety of collected data, the recording and guiding before, during and after a teaching process of a following teacher cannot only be realized, but also a voice of the following teacher can be evaluated so as to facilitate the following teacher in effectively completing local class teaching.

What is claimed:

1. A following teaching system having a voice evaluation function, with the following teaching system being based on an Internet teaching platform and the Internet teaching platform having a class teaching recording function, the following teaching system comprising the following units:
a standard course forming unit for collecting standard class teaching data of a standard teacher by using a standard teaching recording and broadcasting system of the Internet teaching platform, and processing the standard class teaching data in segments, for example, in a pre-class test stage, a class lecturing stage and an in-class practice stage, wherein each of the stages is identified and distinguished by using information about a time identifier, and the information about a time identifier is saved together with the class teaching data so as to constitute standard teaching recorded and broadcast data, thereby forming a standard teaching recorded and broadcast course;
a following teaching recording unit for collecting following class teaching data of a following teacher by using a following teaching recording and broadcasting system of the Internet teaching platform, analyzing pre-class test result data of the following class teaching data in real time, comparing the results analyzed in real time with corresponding data of the standard teaching recorded and broadcast data, setting a suggested lecturing time for a class lecturing stage of the following teacher according to a comparison result, and recording the suggested lecturing time and an actual lecturing time, wherein the suggested lecturing time and the actual lecturing time are saved together with the class teaching data so as to constitute following teaching recorded and broadcast data, thereby forming a following teaching recorded and broadcast course, and the following teaching recorded and broadcast data comprises the voice data of the following teacher;
a following teaching analysis unit for analyzing the following teaching recorded and broadcast data ex post facto, comparing same with the standard teaching recorded and broadcast data in segments, including the comparison between the suggested lecturing time and the actual lecturing time in each of the stages, and the comparison of information about voice text in each of the stages, and synchronously playing back the following teaching recorded and broadcast course and the standard teaching recorded and broadcast course and displaying same to the following teacher; and
a following voice evaluation unit for comparing a teaching voice of the following teacher with a standard teaching voice and marking a comparison result on voice text of the following teacher.

2. The following teaching system according to claim 1, wherein
the standard course forming unit specifically comprises:
a relational data construction unit for dividing knowledge points of a class syllabus of each course, generating keywords by using the knowledge points as data items and according to the knowledge points, establishing a correlation between the keywords and the knowledge points, and establishing, on the basis of the data items and according to the comparison of information about attributes between exercises in a pre-class test and exercises in in-class practice, an association relationship, which takes the knowledge points as associated points, among various types of data, thereby constructing a relational database;
a standard teaching recording unit for collecting the standard class teaching data by using a teaching recording device of the standard teaching recording and broadcasting system, wherein image data, audio data and motion data can be collected respectively by using an image collection device, an audio collection device and/or a motion collection device, and the data can be respectively saved in the form of data streams and can be time stamped by a time stamp;
a pre-class test analysis unit for performing real-time analysis on test results of a basic knowledge test conducted by a student over a student terminal after the start of class teaching and before the class lecturing stage, so as to form pre-class test result analysis data;
an in-class practice analysis unit for performing real-time analysis on test results of an in-class practice test conducted by a student over a student terminal before the end of class teaching and after the class lecturing stage, so as to form in-class practice result analysis data; and
a voice recognition and conversion unit for converting audio data of the class teaching data into information about voice text by using a voice recognition technology, and counting word frequency numbers of keywords in information about standard voice text corresponding to each of the knowledge points.

3. The following teaching system according to claim 2, wherein
the information about standard voice text comprises information about a time stamp of the audio data, such that a correlation between voice text and the audio data can be established based on the information about a time stamp, and thus the information about standard voice text can be displayed in the form of subtitles when the standard teaching recorded and broadcast course is played back on-demand.

4. The following teaching system according to claim 2, wherein
the division of the knowledge points comprises three steps:
step I: dividing the class syllabus into basic knowledge and newly lectured knowledge to serve as a first-level data item;
step II: further dividing the basic knowledge into several basic knowledge points, and further dividing the newly lectured knowledge into several newly lectured knowledge points to serve as a second-level data item;
and step III: based on the association relationship between the basic knowledge points and the newly lectured knowledge points, further improving the data structure of the relational database.

5. The following teaching system according to claim 2, wherein
the following teaching recording unit specifically comprises:
a relational data invoking unit for retrieving the relational database at the beginning of following class teaching, so as to provide data support for the following execution of unit functions;
a following teaching data collection unit for collecting the following class teaching data by using a teaching recording device of a following teaching recording and broadcasting system, wherein image data, audio data and motion data are collected respectively by using an image collection device, an audio collection device and/or a motion collection device, and the data can be respectively saved in the form of data streams and can be time stamped by a time stamp;
a pre-class test comparison unit for performing real-time analysis on test results of a basic knowledge test conducted by a student over a student terminal after the start of following class teaching and before a following class lecturing stage so as to form pre-class test result analysis data, comparing the pre-class test analysis result with a pre-class test analysis result of a standard course, providing, to the following teacher, the student's master of the basic knowledge points as well as the difference between the student and a student in a standard class, and giving a suggested lecturing time concerning the knowledge points according to the difference and information about an association of the knowledge points in the relational database in conjunction with a lecturing time for the knowledge points in standard class; and
an in-class practice analysis unit for performing real-time analysis on test results of an in-class practice test conducted by a student over a student terminal before the end of class teaching and after the class lecturing stage, so as to form in-class practice result analysis data.

6. The following teaching system according to claim 5, wherein
the exercises in the pre-class test and the exercises in the in-class practice are consistent with the corresponding exercises in standard teaching.

7. The following teaching system according to claim 5, wherein
after the giving of the suggested lecturing time, information about a time prompt is generated and presented on a teacher terminal, making it convenient for the following teacher to control the teaching progress in class lecturing.

8. The following teaching system according to claim 2, wherein
the following teaching analysis unit specifically comprises:
a voice recognition and conversion unit for converting audio data of the following teaching recorded and broadcast data into information about voice text by using a voice recognition technology, and counting word frequency numbers of keywords in information about following voice text corresponding to each of the knowledge points, wherein the keywords are consistent with keywords in a standard course;
a text similarity analysis unit for performing comparative analysis on the word frequency numbers of the keywords corresponding to each of the knowledge points in the information about standard voice text and the word frequency numbers of the keywords corresponding to each of the knowledge points in the information about following voice text, so as to determine the similarity between the information about following voice text and the information about standard voice text; and
a split-screen comparison presentation unit for simultaneously presenting, to the following teacher, the recorded following teaching course and a standard teaching course in the manner of double-window or multi-window on the same screen or in the manner of multi-screen synchronous display, thereby realizing intuitive comparison.

9. The following teaching system according to claim 8, wherein
the split-screen comparison presentation unit can also perform the following functions: the comparison of the pre-class test analysis results, the comparison between the suggested lecturing time and the actual lecturing time, the comparison of similarity between the information about following voice text and the information about standard voice text, and/or the comparison of in-class practice test results.

10. The following teaching system according to claim 9, wherein
the following teaching analysis unit further comprises:
an improvement suggestion generation unit for giving, during split-screen comparison presentation, information about an evaluation and an improvement suggestion for each of the stages during following teaching according to the knowledge point-based association relationship, which is determined according to the relational database, among various types of data in conjunction with the comparison results.

11. The following teaching system according to claim 10, wherein
the following teaching analysis unit further comprises:
a following degree calculation unit for calculating a following coefficient Fₙ for each following teaching, and making multiple following coefficients Fₙ in a certain period into a following coefficient change curve and presenting same to the following teacher, wherein the formula for calculating the following coefficient is:
$${F}_{n} = 1 - ( α ( {\sum }_{1}^{n} {δ}_{1} ( \frac{\vert {ST}_{1} - {PT}_{1} \vert}{{ST}_{1}} ) + … + {δ}_{i} ( \frac{\vert {ST}_{i} - {PT}_{i} \vert}{{ST}_{i}} ) ) + β ( \frac{\vert E 1 - E 2 \vert}{E 2} ) + γ ( \frac{\vert S 1 - S 2 \vert}{S 2} ) )$$
where
STᵢ represents a suggested lecturing time of a knowledge point i, PTᵢ represents an actual lecturing time of the knowledge point i, i=1, 2 . . . n, n being a positive integer and used for representing the number of knowledge points, and δrepresents a weight coefficient for an ith knowledge point, where δ₁+ . . . +δᵢ=1;
E1 represents evaluation data for the teaching of the following teacher, E2 represents evaluation data for the teaching of the standard teacher, the evaluations are usually given by the student over the Internet teaching platform, and the two pieces of evaluation data adopt the same standard;
S1 represents an average score for all in-class practice in a following class, and S2 represents an average score for all in-class practice in a standard class; and
α, β, γ are used as balance coefficients, α+β+γ=1, the value of α is 0.30-0.50, the value of β is 0.10-0.30, and the value of γ is 0.20-0.40.

12. The following teaching system according to claim 2, wherein
the following voice evaluation unit comprises an input voice acquisition unit, a voice segment division unit, a temperament feature acquisition unit, a to-be-evaluated content determination unit, a standard voice generation unit, a voice comparison and analysis unit, and a comparison result generation unit, wherein
the input voice acquisition unit is used for acquiring voice data of the following teacher from the following teaching recorded and broadcast data in the following teaching recording unit;
the voice segment division unit is used for performing basic voice segment division on the voice data, so as to obtain a voice unit sequence of the voice data;
the temperament feature acquisition unit is used for performing feature extraction on the voice unit sequence, so as to acquire a temperament feature of the voice unit sequence;
the to-be-evaluated content determination unit is used for performing feature calculation on the extracted temperament feature, and using, if a calculation result satisfies a predetermined condition, a vocal unit that meets the condition as to-be-evaluated content;
the voice comparison and analysis unit is used for acquiring a temperament feature of the to-be-evaluated content, and performing comparison and analysis on the temperament feature and a standard teaching voice of the standard voice generation unit; and
the comparison result generation unit is used for marking a voice evaluation result on voice text of the following teacher and providing same to the following teacher.

13. The following teaching system according to claim 12, wherein
the standard voice generation unit is used for recognizing and converting the voice data of the following teacher into information about voice text, and then generating a standard teaching voice of the following teacher by using a standard pronunciation database according to the information about voice text.

14. The following teaching system according to claim 13, wherein
the conversion of the voice text of the following teacher can be performed by the voice recognition and conversion unit of the following teaching analysis unit.
